(19) United States
(12) Patent Application Publication
(10) Pub. No.: US 2017/0019679 A1
(43) Pub. Date: Jan. 19, 2017

(54) HYBRID VIDEO DECODING APPARATUS FOR PERFORMING HARDWARE ENTROPY DECODING AND SUBSEQUENT SOFTWARE DECODING AND ASSOCIATED HYBRID VIDEO DECODING METHOD

(71) Applicant: MEDIATEK INC., Hsin-Chu (TW)

(72) Inventors: Sheng-Jen Wang, Tainan City (TW); Ming-Long Wu, Taipei City (TW); Chia-Yun Cheng, Hsinchu County (TW); Yung-Chang Chang, New Taipei City (TW); Hao-Chun Chung, Hsinchu County (TW); Yu-Cheng Chu, Hsinchu City (TW); Shen-Kai Chang, Hsinchu County (TW)

(21) Appl. No.: 15/202,538

(22) Filed: Jul. 5, 2016

Related U.S. Application Data
(60) Provisional application No. 62/192,748, filed on Jul. 15, 2015.

(51) Int. Cl. H04N 19/50; H04N 19/176; H04N 19/91; H04N 19/70; H04N 19/44

(52) U.S. Cl. CPC H04N 19/50; H04N 19/70; H04N 19/44; H04N 19/91; H04N 19/176

(57) ABSTRACT

A hybrid video decoding apparatus has a hardware entropy decoder and a storage device. The hardware entropy decoder performs hardware entropy decoding to generate an entropy decoding result of a picture. The storage device has a plurality of storage areas allocated to buffer a plurality of entropy-decoded partial data, respectively, and is further arranged to store position information indicative of storage positions of the entropy-decoded partial data in the storage device. The entropy-decoded partial data are derived from the entropy decoding result of the picture, and are associated with a plurality of portions of the picture, respectively.

### CROSS REFERENCE TO RELATED APPLICATIONS

This application claims the benefit of U.S. provisional application No. 62/192,748, filed on Jul. 15, 2015 and incorporated herein by reference.

### BACKGROUND

The present invention relates to a video decoder design, and more particularly, to a hybrid video decoding apparatus for performing hardware entropy decoding and subsequent software decoding and an associated hybrid video decoding method.

The conventional video coding standards generally adopt a block based coding technique to exploit spatial and temporal redundancy. For example, the basic approach is to divide the whole source frame into a plurality of blocks, perform prediction on each block, transform residuals of each block, and perform quantization, scan and entropy encoding. Besides, a reconstructed frame is generated in an internal decoding loop of the video encoder to provide reference pixel data used for coding following blocks. For example, inverse scan, inverse quantization, and inverse transform may be included in the internal decoding loop of the video encoder to recover residuals of each block that will be added to predicted samples of each block for generating a reconstructed frame. A video decoder is arranged to perform an inverse of a video encoding process performed by a video encoder. For example, a typical video decoder includes an entropy decoding stage and subsequent decoding stages. With regard to a conventional software-based video decoding system, the entropy decoding stage is generally a performance bottleneck due to high dependency of successive syntax parsing. Thus, there is a need for an innovative video decoder design with improved decoding efficiency.

### SUMMARY

One of the objectives of the claimed invention is to provide a hybrid video decoding apparatus for performing hardware entropy decoding and subsequent software decoding and an associated hybrid video decoding method.

According to a first aspect of the present invention, an exemplary hybrid video decoding apparatus is disclosed. The exemplary hybrid video decoding apparatus includes a hardware entropy decoder and a storage device. The hardware entropy decoder is arranged to perform hardware entropy decoding to generate an entropy decoding result of a picture. The storage device has a plurality of storage areas allocated to buffer a plurality of entropy-decoded partial data, respectively, and is further arranged to store position information indicative of storage positions of the entropy-decoded partial data in the storage device, wherein the entropy-decoded partial data are derived from the entropy decoding result of the picture, and are associated with a plurality of portions of the picture, respectively.

According to a second aspect of the present invention, an exemplary hybrid video decoding method is disclosed. The exemplary hybrid video decoding method includes: performing hardware entropy decoding to generate an entropy decoding result of a picture; allocating a plurality of storage areas in a storage device to buffer a plurality of entropy-decoded partial data, respectively, wherein the entropy-decoded partial data are derived from the entropy decoding result of the picture, and are associated with a plurality of portions of the picture, respectively; and storing position information into the storage device, wherein the position information is indicative of storage positions of the entropy-decoded partial data in the storage device.

According to a third aspect of the present invention, an exemplary hybrid video decoding apparatus is disclosed. The exemplary hybrid video decoding apparatus includes a hardware entropy decoder and a multi-core processor system. The hardware entropy decoder is arranged to perform hardware entropy decoding to generate an entropy decoding result of a picture. The multi-core processor system is arranged to execute a decoding program to perform software decoding upon a plurality of entropy-decoded partial data in a parallel processing fashion, wherein the entropy-decoded partial data are derived from the entropy decoding result of the picture, and are associated with a plurality of portions of the picture, respectively.

According to a fourth aspect of the present invention, an exemplary hybrid video decoding method is disclosed. The exemplary hybrid video decoding method includes: performing hardware entropy decoding to generate an entropy decoding result of a picture; and executing a decoding program, by a multi-core processor system, to perform software decoding upon a plurality of entropy-decoded partial data in a parallel processing fashion, wherein the entropy-decoded partial data are derived from the entropy decoding result of the picture, and are associated with a plurality of portions of the picture, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a hybrid video decoding apparatus according to an embodiment of the present invention.

FIG. 2 is a diagram illustrating a detailed hybrid video decoding design according to an embodiment of the present invention.

FIG. 3 is a diagram illustrating an exemplary design of the hardware entropy decoder shown in FIG. 1.

FIG. 4 is a flowchart illustrating an entropy decoding method according to an embodiment of the present invention.

FIG. 5 is a diagram illustrating a data storage layout of a row byte count buffer according to an embodiment of the present invention.

FIG. 6 is a diagram illustrating a first design of recording the position information in a row byte count buffer according to an embodiment of the present invention.

FIG. 7 is a diagram illustrating a second design of recording the position information in a row byte count buffer according to an embodiment of the present invention.

FIG. 8 is a diagram illustrating a third design of recording the position information in a row byte count buffer according to an embodiment of the present invention.

FIG. 9 is a diagram illustrating a decoding order of decoding units in a picture partitioned into tiles.

FIG. 10 is a diagram illustrating a side information buffer which stores entropy-decoded partial data of a plurality of rows in a picture that is partitioned into a plurality of tiles according to two vertical tile boundaries and one horizontal tile boundary.

FIG. 11 is a diagram illustrating a row byte count buffer with a first exemplary storage arrangement of position information that is indicative of storage positions of entropy-decoded partial data of rows in a multi-tile picture.

FIG. 12 is a diagram illustrating a row byte count buffer with a second exemplary storage arrangement of position information that is indicative of storage positions of entropy-decoded partial data of rows in a multi-tile picture.

FIG. 13 is a diagram illustrating a row byte count buffer with a third exemplary storage arrangement of position information that is indicative of storage positions of entropy-decoded partial data of rows in a multi-tile picture.

FIG. 14 is a diagram illustrating a side information buffer with storage areas each having a predetermined size.

FIG. 15 is a diagram illustrating a side information buffer with storage areas each having a variable size.

FIG. 16 is a diagram illustrating a picture level pipeline design employed by a hybrid video decoding apparatus according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

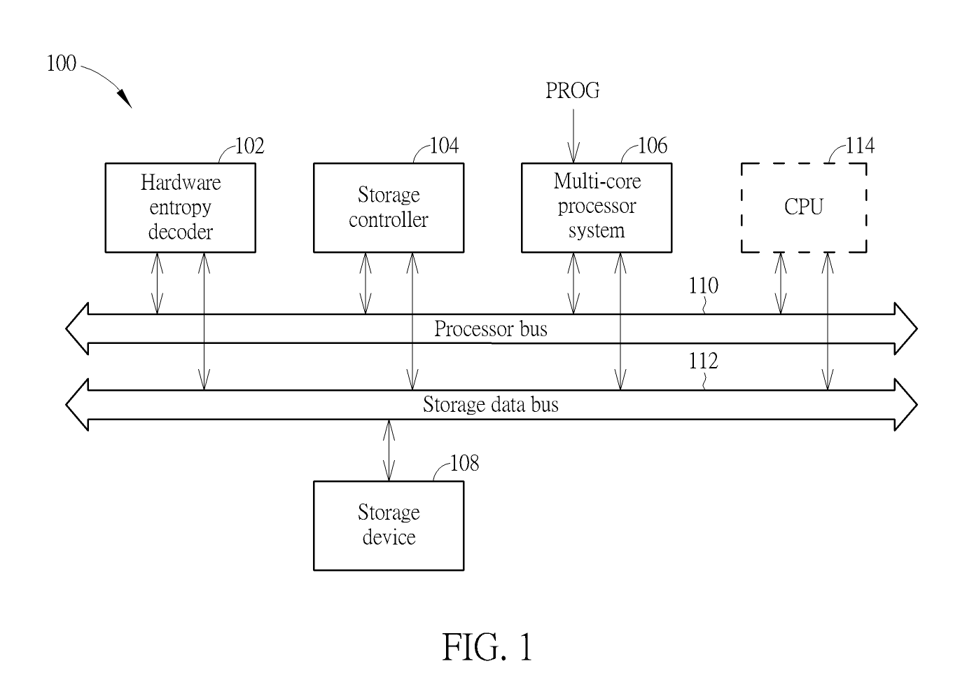

FIG. 1 is a diagram illustrating a hybrid video decoding apparatus according to an embodiment of the present invention. The hybrid video decoding apparatus 100 may be part of an electronic device. The hybrid video decoding apparatus 100 includes, but not limited to, a plurality of circuit elements, such as a hardware entropy decoder 102, a storage controller 104, a multi-processor system 106, a storage device 108, a processor bus 110, and a storage data bus 112. In this embodiment, the storage device 108 may be a memory device such as a dynamic random access memory (DRAM), and the storage controller 104 may be a memory controller such as a DRAM controller. Hence, the multi-core processor system 106 and/or the hardware entropy decoder 102 can access the storage device 108 by issuing read/write requests to the storage controller 104. Specifically, the multi-core processor system 106 and/or the hardware entropy decoder 102 can communicate with the storage controller 104 via the storage data bus (e.g., DRAM data bus) 112. The multi-core processor system 106 includes a plurality of processor cores such as central processing unit (CPU) cores and/or graphics processing unit (GPU) cores. In a case where the multi-core processor system 106 is a multi-core CPU system, the multi-core CPU system manages the overall operation of the hybrid video decoding apparatus 100 by controlling circuit components via the processor bus 110. In another case where the multi-core processor system 106 is a multi-core GPU system, the hybrid video decoding apparatus 100 may further include a CPU 114 arranged to manage the overall operation of the hybrid video decoding apparatus 100 by controlling circuit components via the processor bus 110.

With regard to the proposed hybrid video decoding design, the video decoding flow is divided into a hardware-based decoding process and a software-based decoding process. In this embodiment, the hardware-based decoding process includes an entropy decoding function, and the software-based decoding process includes subsequent decoding functions which are based on an entropy decoding result. The hardware entropy decoder 102 is to deal with the hardware-based decoding process, and the multi-core processor system (e.g., multi-core CPU system or multi-core GPU system) 106 is to deal with the software-based decoding process. In this embodiment, the hardware entropy decoder 102 may be a dedicated circuit designed to perform hardware entropy decoding to generate an entropy decoding result of a picture. The multi-core processor system 106 may execute a decoding program PROG to perform software decoding upon a plurality of entropy-decoded partial data in a parallel processing fashion, wherein the entropy-decoded partial data are derived from the entropy decoding result of the picture, and are associated with a plurality of portions of the picture, respectively. Further details of the proposed hybrid video decoding design are described as below.

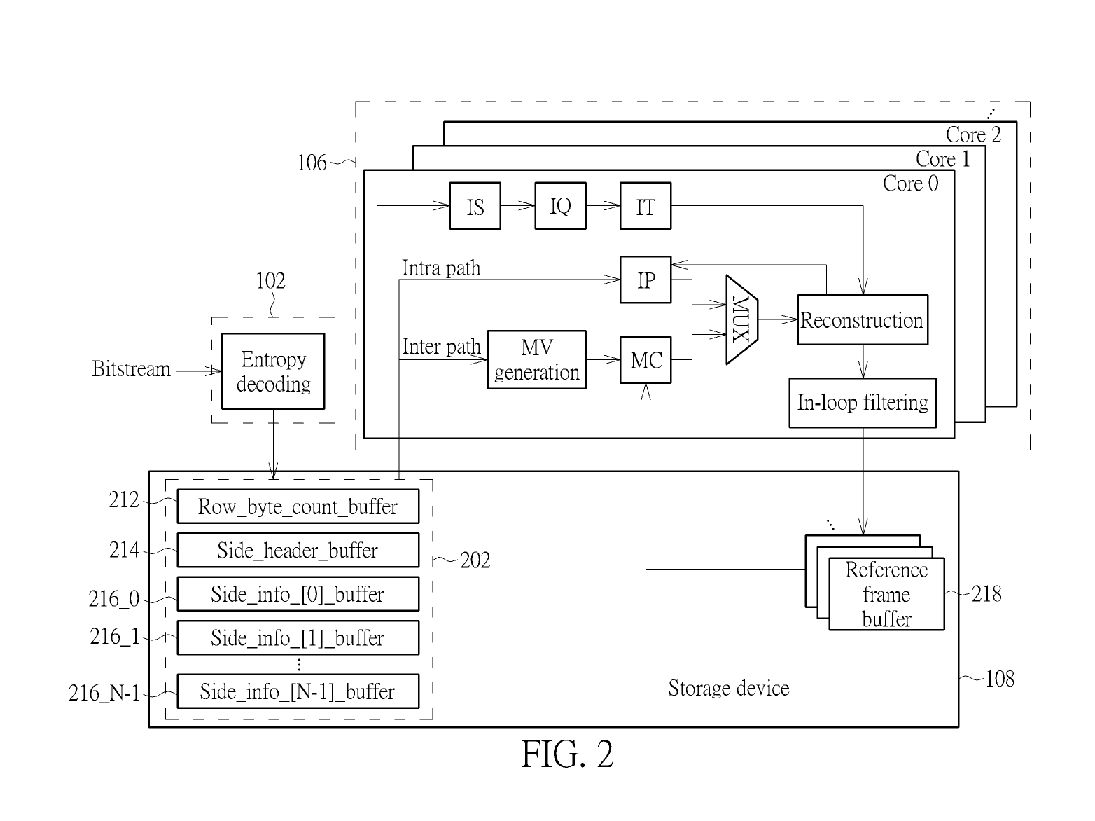

FIG. 2 is a diagram illustrating a detailed hybrid video decoding design according to an embodiment of the present invention. The hardware entropy decoder 102 receives a bitstream carrying encoded data of a picture, and performs hardware entropy decoding to generate an entropy decoding result of the picture to an entropy decoding output buffer 202 allocated in the storage device 108. In this embodiment, the entropy decoding output buffer 202 includes a row byte count buffer (denoted by “Row_byte_count_buffer”) 212, a slice header buffer (denoted by “Slice_header_buffer”) 214, and a plurality of side information buffers (denoted by “Side_info_[0]_buffer” and “Side_info_[N−1]_buffer”) 216_0-216_N−1. The slice header buffer 214 is used to store all slice header information of the picture. The picture may be divided into a plurality of portions. In this embodiment, each portion of the picture may be one row in the picture. For example, the width of one row mentioned hereinafter may be equal to the picture width. In a first case where the video coding standard is H.264/MPEG4/MPEG2, one row mentioned hereinafter may be referred to as a single MB (Macroblock) row or may be referred to as multiple MB rows. In a second case where the video coding standard is HEVC (High Efficiency Video Coding), one row mentioned hereinafter may be referred to as a single CTB (Code Tree Block) row or may be referred to as multiple CTB rows. In a third case where the video coding standard is VP9, one row mentioned hereinafter may be referred to as a single SB (Superblock) row or may be referred to as multiple SB rows.

When the picture is further partitioned into tiles under certain video coding standard (e.g. , HEVC or VP9), adjacent rows may be separated by one tile boundary. For example, the width of one row may be shorter than the picture width. In a first case where the video coding standard is HEVC and the picture is partitioned into tiles, one row mentioned hereinafter may be referred to as a single CTB row of one tile or may be referred to as multiple CTB rows of one tile. In a second case where the video coding standard is VP9, one row mentioned hereinafter may be referred to as a single SB row of one tile or may be referred to as multiple SB rows of one tile.

Alternatively, sizes of portions of the picture may be user-defined. For example, even though there is no tile boundary in the picture, adjacent rows may be separated by one user-defined boundary. That is, the width of one row mentioned hereinafter may be user-defined and may be shorter than the picture width. In a first case where the video coding standard is H.264/MPEG4/MPEG2, one row mentioned hereinafter may be referred to as a single user-defined MB row or may be referred to as multiple user-defined MB rows. In a second case where the video coding standard is HEVC, one row mentioned hereinafter may be referred to as a single user-defined CTB row or may be referred to as multiple user-defined CTB rows. In a third case where the video coding standard is VP9, one row mentioned hereinafter may be referred to as a single user-defined SB row or may be referred to as multiple user-defined SB rows.

Each of the side information buffers 216_0-216_N−1 is used to store a plurality of entropy-decoded partial data derived from the entropy decoding result of the picture and associated with different rows (e.g., a single MB/CTB/SB row or multiple MB/CTB/SB rows) of the picture, respectively. For example, the side information buffer 216_0 may serve as an H.264 MB layer information buffer for different rows in the picture, or may serve as an HEVC CTB layer information buffer for different rows in the picture; and the side information buffer 216_1 may serve as a transform coefficient buffer for different rows in the picture. Other side information may be required under certain video coding standards. For example, when the video coding standard is HEVC, additional side information buffers 216_N−1 (N>2) may include one side information buffer serving as an HEVC TU (transform unit) layer information buffer for different rows in the picture and may further include another side information buffer serving as an HEVC CU (coding unit) layer information buffer for different rows in the picture.

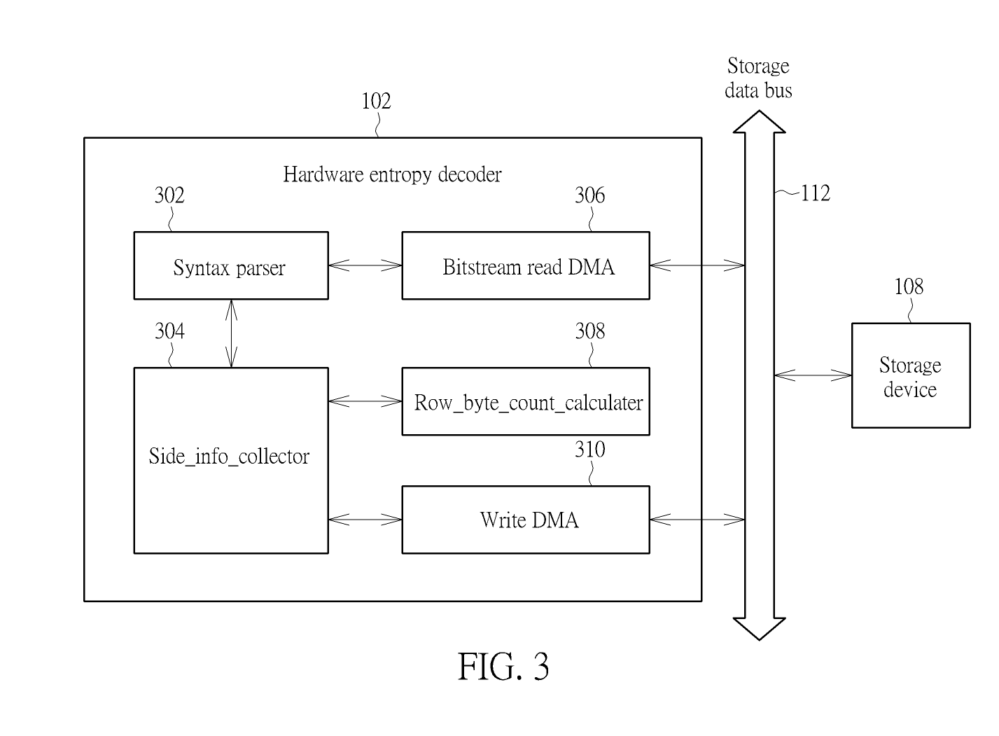

The row byte count buffer 212 is used to store position information indicative of storage positions of entropy-decoded partial data in the storage device 108. Specifically, the position information stored in the row byte count buffer 212 may indicate a storage position of an entropy-decoded partial data of each row in any of the side information buffers 216_0-216_N−1. The position information may be calculated during the hardware entropy decoding performed by the hardware entropy decoder 102. FIG. 3 is a diagram illustrating an exemplary design of the hardware entropy decoder 102 shown in FIG. 1. As shown in FIG. 3, the hardware entropy decoder 102 is implemented by a plurality of circuits, including a syntax parser 302, a side information collector (denoted by “Side_info_collector”) 304, a bitstream read DMA (direct memory access) controller (denoted by “Bitstream read DMA”) 306, a row byte count calculator (denoted by “Row_byte_count calculator”) 308, and a write DMA controller (denoted by “Write DMA”) 310. A bitstream (which carries encoded data of a picture) may be buffered in the storage device (e.g., DRAM) 108. The bitstream read DMA controller 306 is used to read the bitstream data from the storage device 108 via a DMA manner, and then outputs the retrieved bitstream data to the syntax parser 302. The syntax parser 302 is used to perform syntax parsing upon the bitstream data to generate an entropy decoding result of the picture. For example, the syntax parser 302 may employ Huffman VLD (variable length decoding) for MPEG2/MPEG4 syntax parsing, CAVLC (Context Adaptive Variable Length Coding) for H.264 syntax parsing, or CABAC (Context Adaptive Arithmetic Binary Coding) for H.264/HEVC syntax parsing. The side information collector 304 is used to collect the entropy decoding result generated from the syntax parser 302, where the entropy decoding result includes slice header information, transform coefficients, and other decoding related information (e.g., MB layer information for H.264, or CTB layer information, TU layer information and CU layer information for HEVC). The row byte count calculator 308 is used to calculate row byte count information associated with side information to be stored into the side information buffers, namely the storage position information of entropy-decoded partial data of each row in any of the side information buffers 216_0-216_N−1. The write DMA controller 310 is used to write the row byte count information (i.e., storage position information) into the row byte count buffer 212 via a DMA manner, and is further used to write the entropy decoding result of the picture into slice header information buffer 214 and side information buffers 216_0-216_N−1 via a DMA manner.

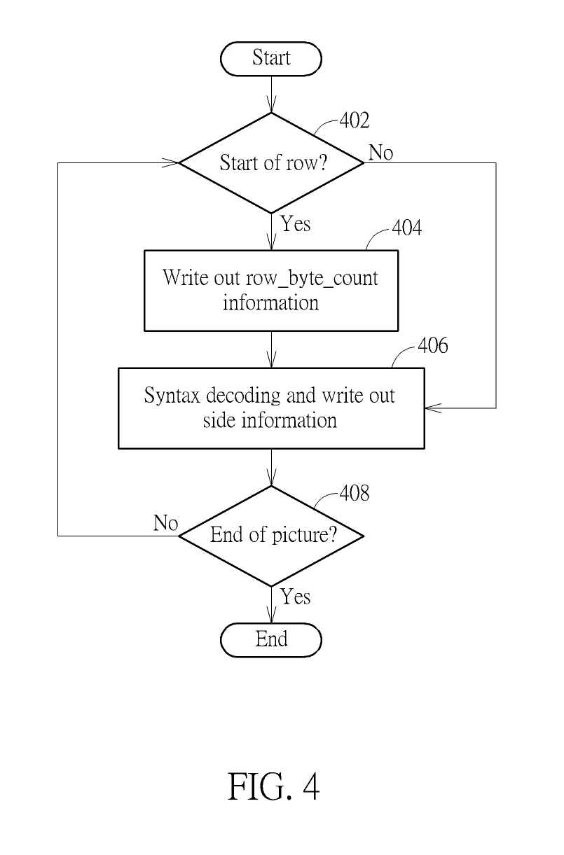

FIG. 4 is a flowchart illustrating an entropy decoding method according to an embodiment of the present invention. Provided that the result is substantially the same, the steps are not required to be executed in the exact order shown in FIG. 4. The entropy decoding method may be employed by the hardware entropy decoder 102 shown in FIG. 3. In step 402, the bitstream read DMA 306 reads the bitstream data from the storage device 108, and the syntax parser 302 determines if a start of one row is encountered. If the start of one row is encountered, the flow proceeds with step 404. In step 404, the row byte count calculator 308 determines row byte count information associated with the current row to be decoded (e.g., storage position information of entropy-decoded partial data of the current row in any of the side information buffers 216_0-216_N−1), and the write DMA controller 310 writes the determined row byte count information associated with the current row to be decoded into the storage device 108. Next, the flow proceeds with step 406. In step 406, the syntax parser 302 performs syntax decoding upon the bitstream data of the current row, the side information collector 304 collects entropy-decoded partial data of the current row, and the write DMA controller 310 writes entropy-decoded partial data of the current row into the storage device 108.

If the start of one row is not encountered yet, the flow proceeds with step 406. In step 406, the syntax parser 302 performs syntax decoding upon the bitstream data of the current row, the side information collector 304 collects entropy-decoded partial data of the current row, and the write DMA controller 310 writes entropy-decoded partial data of the current row into the storage device 108.

In step 408, the syntax parser 302 checks if an end of the picture to be decoded is encountered. If the end of the picture to be decoded is encountered, the entropy decoding of the picture is completed. If the end of the picture to be decoded is not encountered yet, the flow proceeds with step 402.

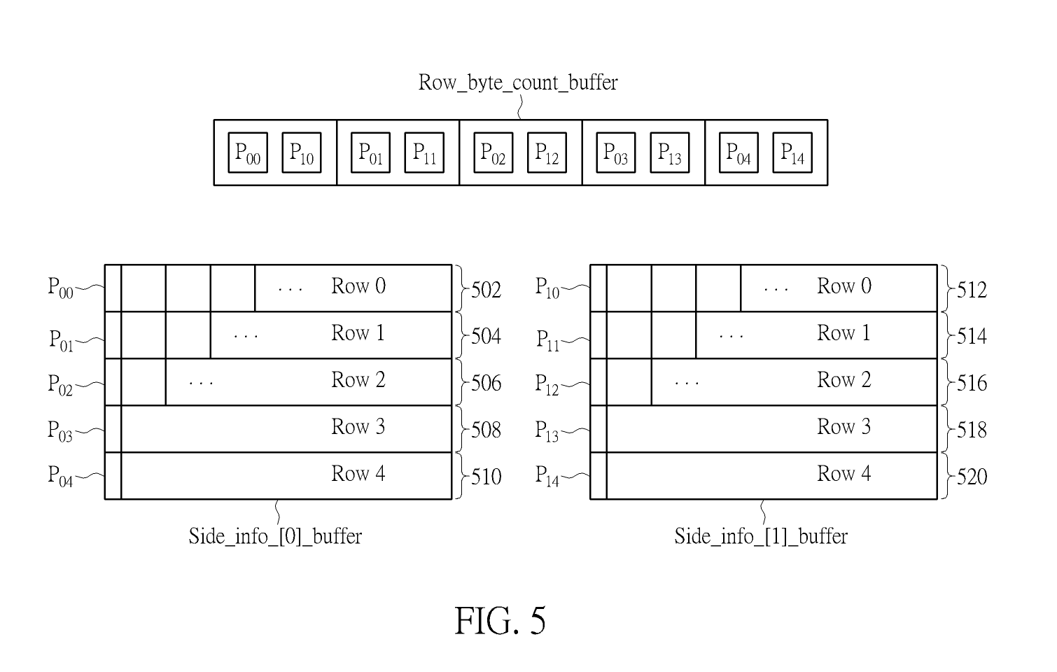

As mentioned above, the row byte count buffer 212 is used to store storage position information of entropy-decoded partial data of each row in any of the side information buffers 216_0-216_N−1. FIG. 5 is a diagram illustrating a data storage layout of the row byte count buffer 212 according to an embodiment of the present invention. For clarity and simplicity, it is assumed that one picture is divided into 5 rows, and there are only two side information buffers required to buffer entropy-decoded partial data of different rows in the picture. As shown in FIG. 5, the side information buffer Side_info_[0]_buffer has five storage areas 502, 504, 506, 508, 510 allocated in the storage device 108 to buffer entropy-decoded partial data (e.g., MB layer information for H.264 or CTB layer information for HEVC) of Row 0 to Row 4 in the picture, and the side information buffer Side_info_[1]_buffer has five storage areas 512, 514, 516, 518, 520 allocated in the storage device 108 to buffer other entropy-decoded partial data (e.g., transform coefficients for H.264 or transform coefficients for HEVC) of Row 0 to Row 4 in the picture. The position information of the storage areas 502, 504, 506, 508, 510 in the side information buffer Side_info_[0]_buffer includes row start addresses P₀₀, P₀₁, P₀₂, P₀₃, P₀₄, and the position information of the storage areas 512, 514, 516, 518, 520 in the side information buffer Side_info_[1]_buffer includes row start addresses P₁₀, P₁₁, P₁₂, P₁₃, P₁₄. In this embodiment, the position information associated with the same row in different side information buffers may be grouped and stored in the row byte count buffer 212. Hence, the row start addresses P₀₀, P₁₀, P₀₁, P₁₁, P₀₂, P₁₂, P₀₃, P₁₃, P₀₄, P₁₄ may be stored at consecutive addresses of the row byte count buffer 212. In this way, the row start addresses P₀₀ and P₁₀ can be read from the row byte count buffer 212 for retrieving the entropy-decoded partial data associated with the same Row 0 from the storage areas 502 and 512 for subsequent software decoding; the row start addresses P₀₁ and P₁₁ can be read from the row byte count buffer 212 for retrieving the entropy-decoded partial data associated with the same Row 1 from the storage areas 504 and 514 for subsequent software decoding; the row start addresses P₀₂ and P₁₂ can be read from the row byte count buffer 212 for retrieving the entropy-decoded partial data associated with the same Row 2 from the storage areas 506 and 516 for subsequent software decoding; the row start addresses P₀₃ and P₁₃ can be read from the row byte count buffer 212 for retrieving the entropy-decoded partial data associated with the same Row 3 from the storage areas 508 and 518 for subsequent software decoding; and the row start addresses P₀₄ and P₁₄ can be read from the row byte count buffer 212 for retrieving the entropy-decoded partial data associated with the same Row 4 from the storage areas 510 and 520 for subsequent software decoding.

In some embodiments of the present invention, the position information (e.g., row start addresses P₀₀, P₀₁, P₀₂, P₀₃, P₀₄) of the storage areas 502, 504, 506, 508, 510 in the side information buffer Side_info_[0]_buffer and the position information (e.g., row start addresses P₁₀, P₁₁, P₁₂, P₁₃, P₁₄) of the storage areas 512, 514, 516, 518, 520 in the side information buffer Side_info_[1]_buffer may be recorded in the row byte count buffer 212 by using count values.

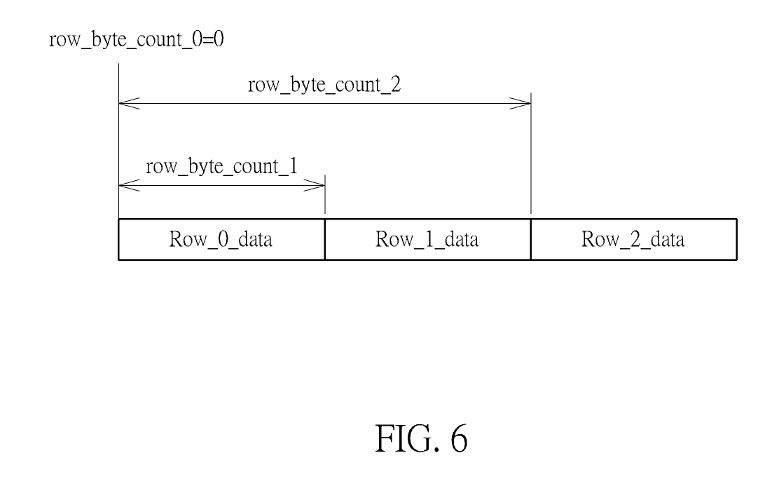

FIG. 6 is a diagram illustrating a first design of recording the position information in a row byte count buffer according to an embodiment of the present invention. In this embodiment, the position information recorded in the row byte count buffer 212 includes a plurality of count values row_byte_count_0, row_byte_count_1, row_byte_count_2 associated with different entropy-decoded partial data Row_0_data, Row_1_data, Row_2_data, respectively. Suppose that the entropy-decoded partial data Row_0_data is associated with the first row in a picture, and is stored into a storage area with a start physical address of a side information buffer. The start storage position of the entropy-decoded partial data Row_0_data is identical to the start position of the side information buffer allocated in the storage device 108. Hence, the count value row_byte_count_0 may be set by 0. The count value row_byte_count_1 indicates a distance between a boundary storage position (e.g., start storage position) of the associated entropy-decoded partial data Row_1_data and a boundary storage position of a specific entropy-decoded partial data (e.g., start storage position of the entropy-decoded partial data Row_0_data). In addition, the count value row_byte_count_2 indicates a distance between a boundary storage position (e.g., start storage position) of the associated entropy-decoded partial data Row_2_data and the boundary storage position of the specific entropy-decoded partial data (e.g., start storage position of the entropy-decoded partial data Row_0_data). Since the physical start address of the side information buffer can be known beforehand, the start storage position of the entropy-decoded partial data Row_0_data can be determined by directly adding the count value row_byte_count_0 (row_byte_count_0=0) to the physical start address of the side information buffer, the start storage position of the entropy-decoded partial data Row_1_data can be determined by directly adding the count value row_byte_count_1 to the physical start address of the side information buffer, and the start storage position of the entropy-decoded partial data Row_2_data can be determined by directly adding the count value row_byte_count_2 to the physical start address of the side information buffer.

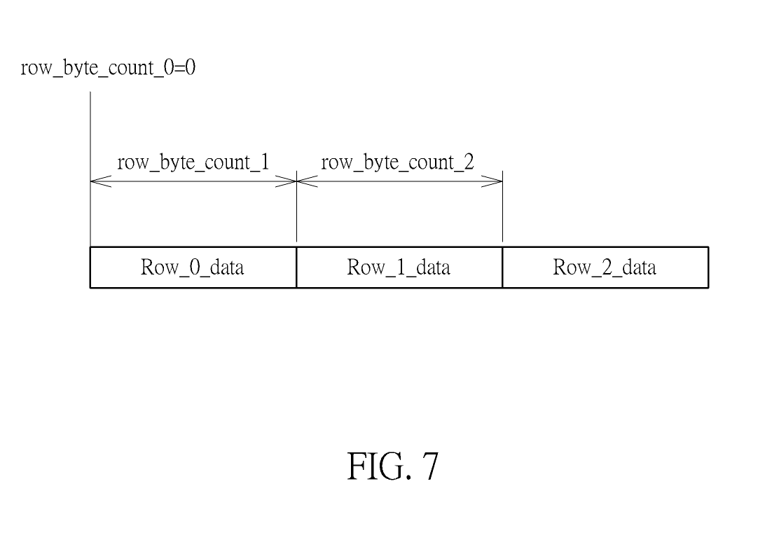

FIG. 7 is a diagram illustrating a second design of recording the position information in a row byte count buffer according to an embodiment of the present invention. In this embodiment, the position information recorded in the row byte count buffer 212 includes a plurality of count values row_byte_count_0, row_byte_count_1, row_byte_count_2 associated with different entropy-decoded partial data Row_0_data, Row_1_data, Row_2_data, respectively. The entropy-decoded partial data Row_0_data, Row_1_data, Row_2_data are adjacent entropy-decoded partial data successively stored in the same side information buffer. Suppose that the entropy-decoded partial data Row_0_data is associated with the first row in a picture, and is stored into a storage area with a start physical address of a side information buffer. The start storage position of the entropy-decoded partial data Row_0_data is identical to the start position of the side information buffer allocated in the storage device 108. Hence, the count value row_byte_count_0 may be set by 0. The count value row_byte_count_1 indicates a distance between a boundary storage position (e.g., start storage position) of the associated entropy-decoded partial data Row_1_data and a boundary storage position of a preceding entropy-decoded partial data (e.g., start storage position of the entropy-decoded partial data Row_0_data). In addition, the count value row_byte_count_2 indicates a distance between a boundary storage position (e.g., start storage position) of the associated entropy-decoded partial data Row_2_data and a boundary storage position of a preceding entropy-decoded partial data (e.g., start storage position of the entropy-decoded partial data Row_1_data). Since the physical start address of the side information buffer can be known beforehand, the start storage position of the entropy-decoded partial data Row_0_data can be determined by directly adding the count value row_byte_count_0 (row_byte_count_0=0) to the physical start address of the side information buffer, the start storage position of the entropy-decoded partial data Row_1_data can be determined by directly adding the count values row_byte_count_0 (row_byte_count_0=0) and row_byte_count_1 to the physical start address of the side information buffer, and the start storage position of the entropy-decoded partial data Row_2_data can be determined by directly adding the count values row_byte_count_0 (row_byte_count_0=0), row_byte_count_1, row_byte_count_2 to the physical start address of the side information buffer.

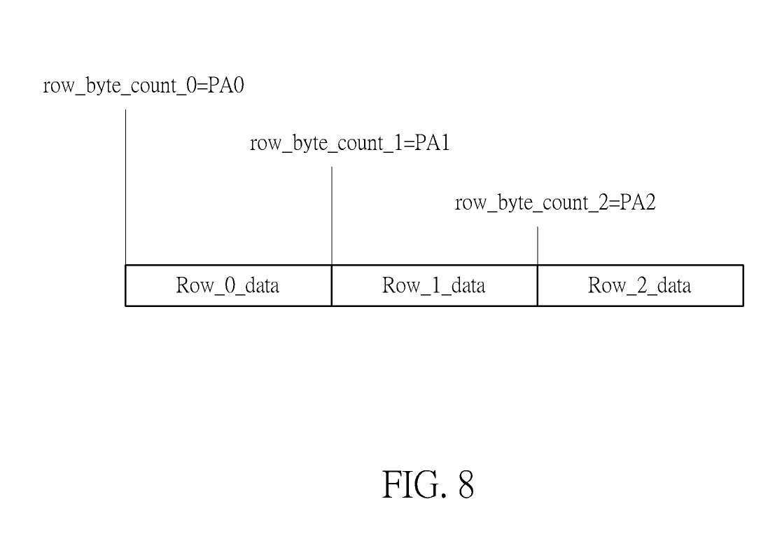

FIG. 8 is a diagram illustrating a third design of recording the position information in a row byte count buffer according to an embodiment of the present invention. In this embodiment, the position information recorded in the row byte count buffer 212 includes a plurality of count values row_byte_count_0, row_byte_count_1, row_byte_count_2 associated with different entropy-decoded partial data Row_0_data, Row_1_data, Row_2_data, respectively. In this embodiment, the count value row_byte_count_0 directly records a physical start address PA0 of the associated entropy-decoded partial data Row_0_data, the count value row_byte_count_1 directly records a physical start address PA1 of the associated entropy-decoded partial data Row_1_data, and the count value row_byte_count_2 directly records a physical start address PA2 of the associated entropy-decoded partial data Row_2_data. Therefore, the start storage position of the entropy-decoded partial data Row_0_data can be determined by directly referring to the count value row_byte_count_0, the start storage position of the entropy-decoded partial data Row_1_data can be determined by directly referring to the count value row_byte_count_1, and the start storage position of the entropy-decoded partial data Row_2_data can be determined by directly referring to the count value row_byte_count_2.

The designs of recording the position information in the row byte count buffer as shown in FIGS. 6-8 are for illustrative purposes only, and are not meant to be limitations of the present invention. In practice, any position information recording design that allows the multi-core processor system 106 to successfully locate and retrieve the needed entropy-decoded partial data from the storage device 108 (particularly, the side information buffers 216_0-216_N−1) may be employed by the hybrid video decoding apparatus 100.

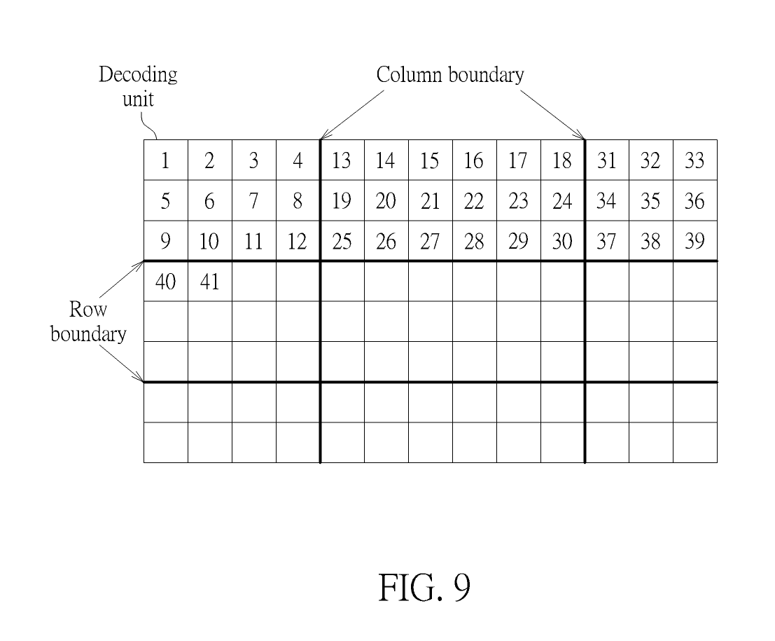

One picture may be partitioned into tiles under certain video coding standard (e.g., HEVC or VP9). FIG. 9 is a diagram illustrating a decoding order of decoding units in a picture partitioned into tiles. As shown in FIG. 9, one picture is partitioned into nine tiles, where there are two column boundaries (vertical tile boundaries) and two row boundaries (horizontal tile boundaries). Each of the tiles includes a plurality of decoding units (e.g., CTBs for HEVC or SBs for VP9). The decoding units in the same tile are decoded in a raster scan order, and the tiles in the same picture are decoded in a raster scan order. Hence, the decoding order of decoding units in the picture partitioned into tiles can be represented by the reference numerals 1, 2, . . . , 40, 41.

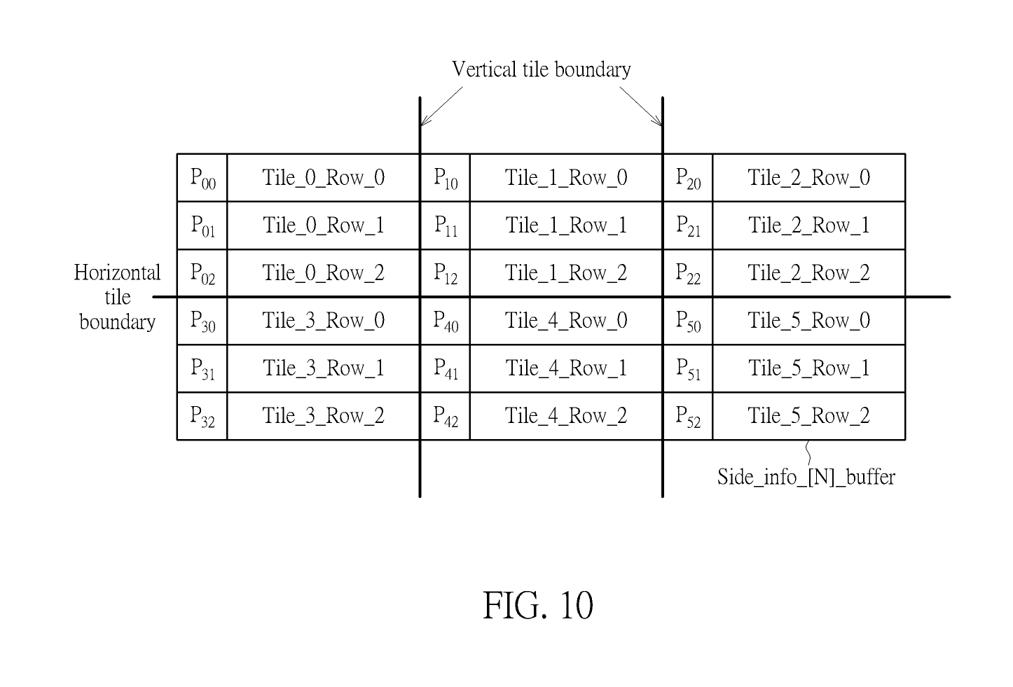

When the picture is partitioned into tiles under certain video coding standard (e.g., HEVC or VP9), adjacent rows may be separated by one tile boundary. In a first case where the video coding standard is HEVC, one row may be referred to as a single CTB row of one tile or may be referred to as multiple CTB rows of one tile. In a second case where the video coding standard is VP9, one row may be referred to as a single SB row of one tile or may be referred to as multiple SB rows of one tile. FIG. 10 is a diagram illustrating a side information buffer side_inf_[N]_buffer which stores entropy-decoded partial data of a plurality of rows in a picture that is partitioned into a plurality of tiles according to two vertical tile boundaries and one horizontal tile boundary.

The position information of storage areas which store entropy-decoded partial data of rows Row 0-Row 2 in the top-left tile Tile 0 includes P₀₀, P₀₁, P₀₂, the position information of storage areas which store entropy-decoded partial data of rows Row 0-Row 2 in the top-middle the Tile 1 includes P₁₀, P₁₁, P₁₂, the position information of storage areas which store entropy-decoded partial data of rows Row 0-Row 2 in the top-right the Tile 2 includes P₂, P₂₁, P₂₂, the position information of storage areas which store entropy-decoded partial data of rows Row 0-Row 2 in the bottom-left tile Tile 3 includes P₃₀, P₃₁, P₃₂, the position information of storage areas which store entropy-decoded partial data of rows Row 0-Row 2 in the bottom-middle the Tile 4 includes P₄₀, P₄₁, P₄₂, and the position information of storage areas which store entropy-decoded partial data of rows Row 0-Row 2 in the bottom-right tile Tile 5 includes P₅₀, P₅₁, P₅₂. The position information P₀₀-P₀₂, P₁₀-P₁₂, P₂₀-P₂₂, P₃₀-P₃₂, P₄₀-P₄₂, P₅₀-P₅₂ may be recoded using count values according to any of the exemplary designs shown in FIGS. 6-8.

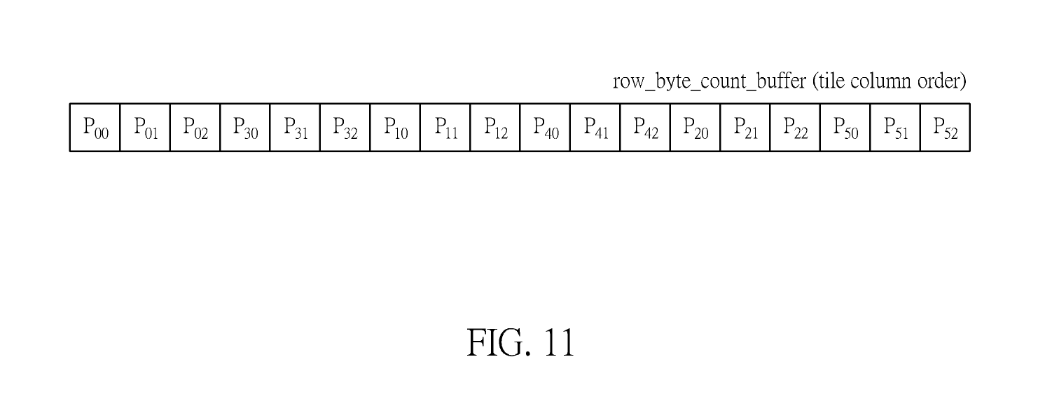

The position information P₀₀-P₀₂, P₁₀-P₁₂, P₂₀-P₂₂, P₃₀-P₃₂, P₄₀-P₄₂, P₅₀-P₅₂ indicative of storage positions of entropy-decoded partial data of rows in a multi-tile picture may be stored in the row byte count buffer 212 according to a storage arrangement which may be suitable for certain software-based data handling (e.g., error handling or other functions). FIG. 11 is a diagram illustrating a row byte count buffer with a first exemplary storage arrangement of position information that is indicative of storage positions of entropy-decoded partial data of rows in a multi-tile picture. In this embodiment, the position information is arranged in a row byte count buffer by a tile column order. The row byte count buffer has a plurality of storage areas allocated in a sequential order. In accordance with the tile column order, the position information P₀₀-P₀₂, P₃₀-P₃₂ is associated with entropy-decoded data of rows in the left tile column, the position information P₁₀-P₁₂, P₄₀-P₄₂ is associated with entropy-decoded data of rows in the middle tile column, and the position information P₂₀-P₂₂, P₅₀-P₅₂ is associated with entropy-decoded data of rows in the right tile column. Hence, the position information P₀₀-P₀₂, P₃₀-P₃₂, P₁₀-P₁₂, P₄₀-P₄₂, P₂₀-P₂₂, P₅₀-P₅₂ is stored in the sequential storage areas of the row byte count buffer according to the tile column order.

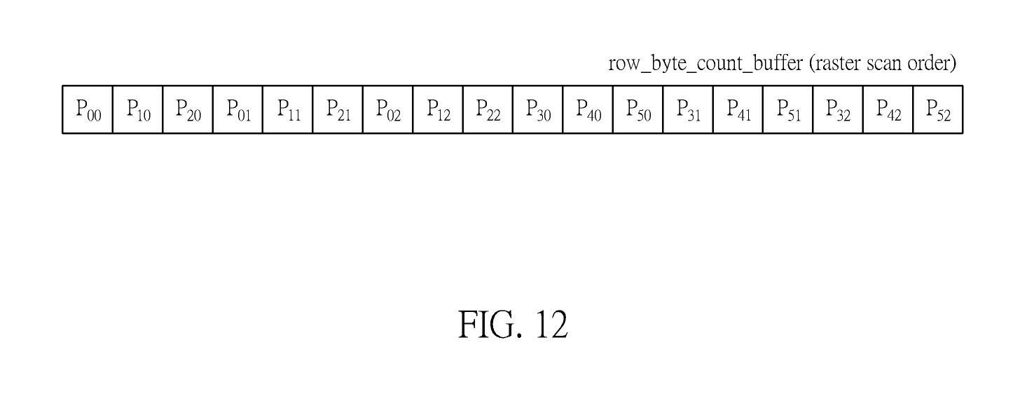

FIG. 12 is a diagram illustrating a row byte count buffer with a second exemplary storage arrangement of position information that is indicative of storage positions of entropy-decoded partial data of rows in a multi-tile picture. With regard to a decoding order of a multi-tile picture, decoding units in the same tile are decoded in a raster scan order, and tiles in the same picture are decoded in a raster scan order. Hence, concerning the multi-tile picture shown in FIG. 10, the top-left tile Tile 0, the top-middle tile Tile 1, the top-right tile Tile 2, the bottom-left tile Tile 3, the bottom-middle tile Tile 4, and the bottom-right tile Tile 5 are decoded sequentially, and the top row Row 0, the middle row Row 1, and the bottom row Row 2 in each tile are decoded sequentially. In this embodiment, the position information is arranged in the row byte count buffer by a specific order different from the above-mentioned decoding order of the multi-tile picture. If the picture is not partitioned into tiles, the specific order (i.e., raster scan order) may be employed as a decoding order of decoding units in the non-tile picture. The rows shown in FIG. 10 will be decoded in a raster scan order if the picture is not partitioned into tiles. For example, the top rows Row 0 of the top-left tile Tile 0, the top-middle tile Tile 1 and the top-right tile Tile 2 will be decoded sequentially, the middle rows Row 1 of the top-left tile Tile 0, the top-middle tile Tile 1 and the top-right tile Tile 2 will be decoded sequentially, the bottom rows Row 0 of the top-left tile Tile 0, the top-middle tile Tile 1 and the top-right tile Tile 2 will be decoded sequentially, and so on. Hence, in this embodiment, the position information P₀₀-P₂₀, P₀₁-P₂₁, P₀₂-P₂₂, P₃₀-P₅₀, P₃₁-P₅₁, P₃₂-P₅₂ is stored in the sequential storage areas of the row byte count buffer according to a raster scan order of a non-tile picture.

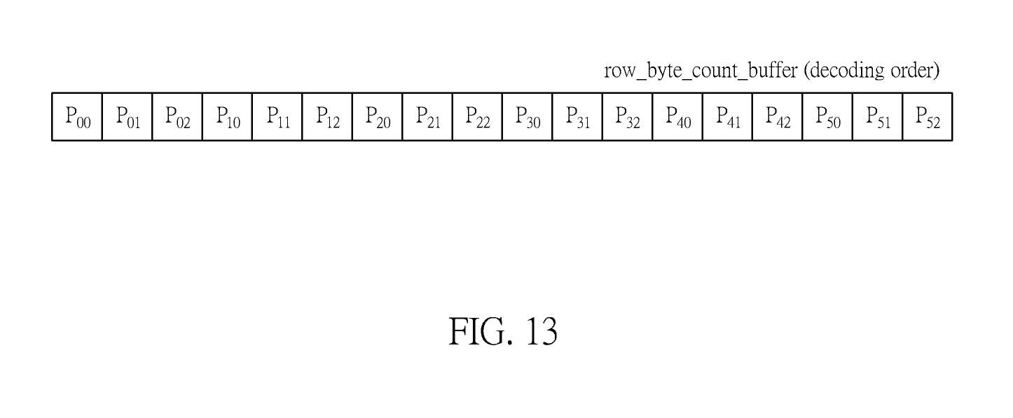

FIG. 13 is a diagram illustrating a row byte count buffer with a third exemplary storage arrangement of position information that is indicative of storage positions of entropy-decoded partial data of rows in a multi-tile picture. In this embodiment, the position information is arranged in the row byte count buffer by a decoding order of entropy-decoded partial data of rows in a multi-tile picture. For example, the rows Row 0-Row2 in the same tile are decoded sequentially, and the tiles Tile 0-Tile 5 in the same picture are decoded sequentially. Hence, in this embodiment, the position information P₀₀-P₀₂, P₁₀-P₁₂, P₂₀-P₂₂, P₃₀-P₃₂, P₄₀-P₄₂, P₅₀-P₅₂ is stored in the sequential storage areas of the row byte count buffer according to the decoding order.

As shown in FIG. 5, the side information buffer Side_info_{—[}0]_buffer has five storage areas 502, 504, 506, 508, 510 allocated in the storage device 108 to buffer entropy-decoded partial data (e.g., MB layer information for H.264 or CTB layer information for HEVC) of Row 0 to Row 4 of the picture, and the side information buffer Side_info_[1]_buffer has five storage areas 512, 514, 516, 518, 520 allocated in the storage device 108 to buffer other entropy-decoded partial data (e.g., transform coefficients for H.264 or transform coefficients for HEVC) of Row 0 to Row 4 of the picture. The storage areas allocated in the storage device 108 may be configured to have fixed/predetermined sizes or variable sizes, depending upon the actual design considerations.

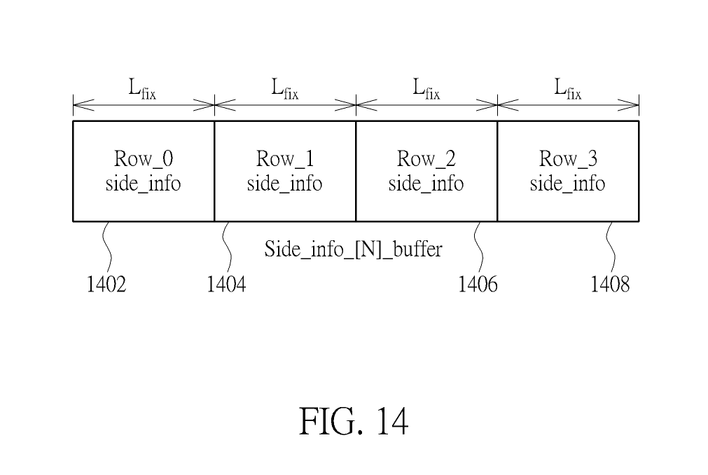

FIG. 14 is a diagram illustrating a side information buffer with storage areas each having a predetermined size. In this embodiment, each of the storage areas allocated for the side information buffer Side_info_[N]_buffer has a fixed size L_{fix} that is predetermined at the time the side information buffer is allocated in the storage device 108. The entropy-decoded partial data Row_0 side_info is stored in a fixed-size storage area 1402, the entropy-decoded partial data Row_1 side_info is stored in a fixed-size storage area 1404, the entropy-decoded partial data Row_2 side_info is stored in a fixed-size storage area 1406, and the entropy-decoded partial data Row_3 side_info is stored in a fixed-size storage area 1408. It should be noted that the fixed size L_{fix} should be properly selected to ensure that the entropy-decoded partial of any row in the picture can be fully stored into one fixed-size storage area. That is, the fixed size L_{fix} is not smaller than the data length of entropy-decoded partial of any row in the picture. When a data length of entropy-decoded partial data of a specific row in the picture is shorter than the fixed size L_{fix} of each storage area allocated for the side information buffer Side_info_[N]_buffer, a specific storage area will have a non-used space after the entropy-decoded partial of the specific row in the picture is stored into the specific storage area. Since all storage areas allocated for the side information buffer Side_info_[N]_buffer have predetermined sizes (e.g. , the same fixed size L_{fix}), the start positions of the storage areas can be known beforehand. In other words, storage positions of entropy-decoded partial data of rows in each side information buffer can be known beforehand. The position information indicative of storage positions of the entropy-decoded partial data in the storage device 108 may not be required to be stored into the row byte count buffer 212, and the row byte count buffer 212 may be omitted. Random access of the entropy-decoded partial data of rows in the side information buffer can be achieved by referring to the predetermined start positions of the storage areas.

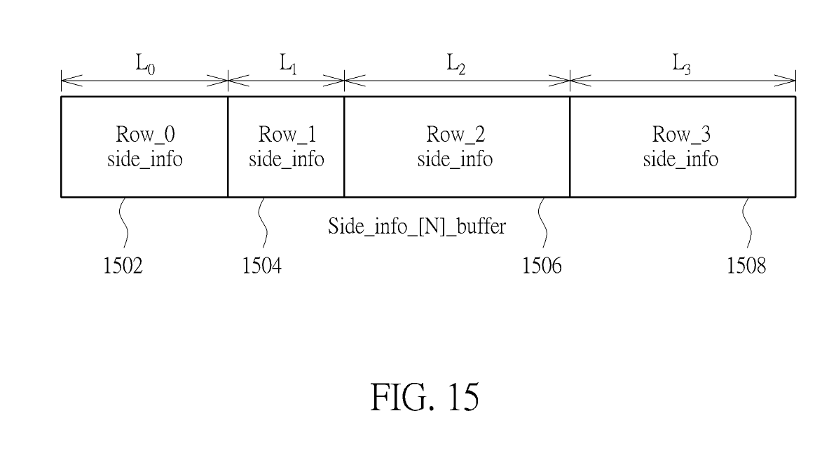

FIG. 15 is a diagram illustrating a side information buffer with storage areas each having a variable size. In this embodiment, each of the storage areas allocated for the side information buffer Side_info_[N]_buffer has a variable size that is adaptively set according to a data length of an entropy-decoded partial data stored into the storage area. As shown in FIG. 15, the entropy-decoded partial data Row_0 side_info with a data length L₀ is stored in a storage area 1502, the entropy-decoded partial data Row_1 side_info with a data length L₁ is stored in a storage area 1504, the entropy-decoded partial data Row_2 side_info with a data length L₂ is stored in a storage area 1506, and the entropy-decoded partial data Row_3 side_info with a data length L₃ is stored in a storage area 1508. Since sizes of the storage areas 1502-1508 are dynamically set for accommodating the entropy-decoded partial data with variable data lengths, the start positions of the storage areas 1502-1508 can't be known beforehand. Therefore, storage positions of entropy-decoded partial data of rows in each side information buffer are required to be stored into the row byte count buffer 212 to thereby enable random access of the entropy-decoded partial data of rows in the side information buffer.

After the entropy decoding result of the picture is stored into the entropy decoding output buffer 202, the multi-core processor system 106 can execute a decoding program PROG to perform software decoding upon a plurality of entropy-decoded partial data read from the entropy decoding output buffer 202 (particularly, side information buffer(s) 216_0-216_N−1) in a parallel processing fashion. In a case where each side information buffer has storage areas each having a predetermined size, each core of the multi-core processor system 106 can refer to predetermined start positions of storage areas in each side information buffer to know the storage position of any requested entropy-decoded partial data. In another case where each side information buffer has storage areas each having a variable size, each core of the multi-core processor system 106 can refer to the position information stored in the row byte count buffer 212 to know the storage position of any requested entropy-decoded partial data.

Please refer to FIG. 2 again. Since the hardware entropy decoding is done by the hardware entropy decoder 102, the multi-core processor system 106 is responsible for performing the subsequent software decoding, where the subsequent software decoding may include intra/inter prediction, reconstruction, post processing, etc. In this embodiment, the multi-core processor system 106 includes a plurality of cores (e.g., Core 0, Core 1 and Core 2 shown in FIG. 2), and one core of the multi-core processor system 106 is arranged to access the storage device 108 (particularly, one of storage areas in each of the side information buffers 216_0-0216_N−1) to retrieve entropy-decoded partial data associated with one row of the picture and then decode the retrieved entropy-decoded partial data associated with one row of the picture. As shown in FIG. 2, the subsequent software decoding performed by each core may include functions selected from inverse scan (IS), inverse quantization (IQ), inverse transform (IT), intra prediction (“IP”), motion vector (MV) generation, motion compensation (MC), intra/inter mode selection (MUX), reconstruction, and in-loop filtering (e.g., deblocking filtering). Reconstructed frames generated from the reconstruction function are further processed by post processing (i.e., in-loop filtering) and then stored into one or more reference frame buffers 218 that may be allocated in the storage device 218.

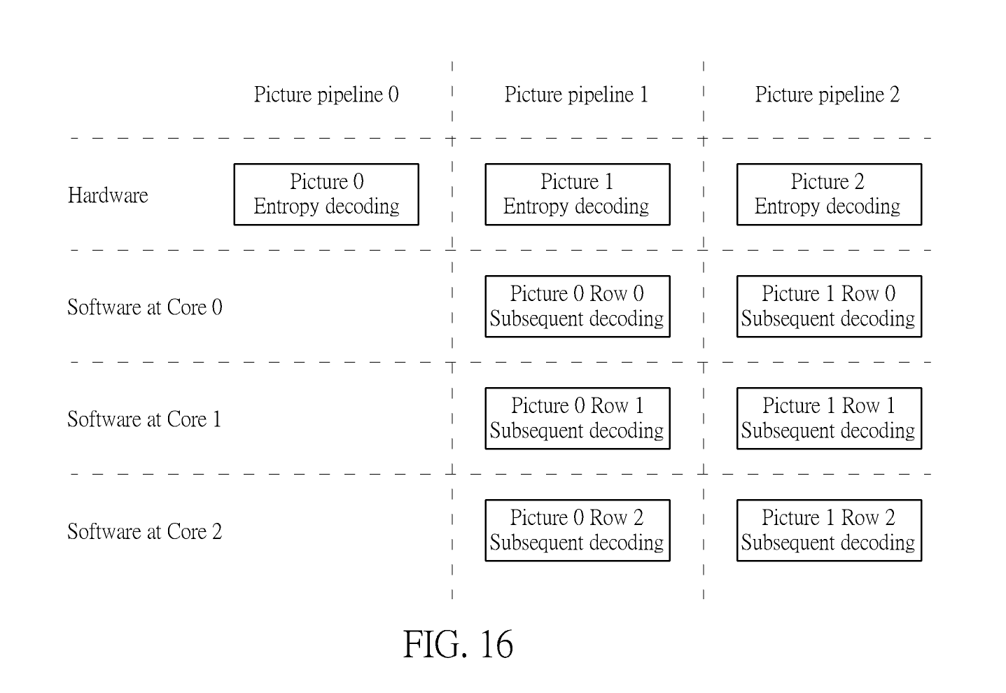

Since the hardware entropy decoder 102 can accomplish the hardware entropy decoding for the whole picture and different cores of the multi-core processor system 106 can accomplish subsequent software decoding of different rows of the same picture in a parallel processing manner, a picture level pipeline design can be employed by such a hybrid video decoding system to achieve improved decoding efficiency. FIG. 16 is a diagram illustrating a picture level pipeline design employed by the hybrid video decoding apparatus 100 according to an embodiment of the present invention. At the picture pipeline 0 phase, the hardware entropy decoder 102 performs hardware entropy decoding of Picture 0. At the picture pipeline 1 phase, the hardware entropy decoder 102 performs hardware entropy decoding of picture 1, and Core 0-Core 2 of the multi-core processor system 106 perform parallel subsequent software decoding of Row 0-Row 2 of Picture 0. At the picture pipeline 2 phase, the hardware entropy decoder 102 performs hardware entropy decoding of Picture 2, and Core 0-Core 2 of the multi-core processor system 106 perform parallel subsequent software decoding of Row 0-Row 2 of Picture 1.

Compared to the software entropy decoding, the hardware entropy decoding performed by dedicated hardware has better entropy decoding efficiency. Hence, compared to the typical software-based video decoding system, the hybrid video decoding system proposed by the present invention is free from the performance bottleneck resulting from the software-based entropy decoding. In addition, the subsequent software decoding, including intra/inter prediction, reconstruction, post processing, etc., can benefit from parallel processing capability of the multi-core processor system. Hence, a high-efficient video decoding system is achieved by the proposed hybrid video decoder design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A hybrid video decoding apparatus comprising:
a hardware entropy decoder, arranged to perform hardware entropy decoding to generate an entropy decoding result of a picture; and
a storage device, having a plurality of storage areas allocated to buffer a plurality of entropy-decoded partial data, respectively, and further arranged to store position information indicative of storage positions of the entropy-decoded partial data in the storage device, wherein the entropy-decoded partial data are derived from the entropy decoding result of the picture, and are associated with a plurality of portions of the picture, respectively.

2. The hybrid video decoding apparatus of claim 1, further comprising:
a multi-core processor system, arranged to execute a decoding program to perform software decoding upon the entropy-decoded partial data in a parallel processing fashion;
wherein one core of the multi-core processor system is arranged to access one of the storage areas to retrieve one entropy-decoded partial data and decode said one entropy-decoded partial data.

3. The hybrid video decoding apparatus of claim 1, wherein each of the storage areas allocated in the storage device has a predetermined size.

4. The hybrid video decoding apparatus of claim 1, wherein each of the storage areas allocated in the storage device has a variable size that is adaptively set according to a data length of an entropy-decoded partial data stored into the storage area.

5. The hybrid video decoding apparatus of claim 1, wherein the position information comprises a plurality of count values associated with the entropy-decoded partial data stored in a buffer allocated in the storage device, respectively; the storage areas are included in the buffer; and each count value indicates a distance between a boundary storage position of an associated entropy-decoded partial data and a start position of the buffer in the storage device.

6. The hybrid video decoding apparatus of claim 1, wherein the position information comprises a plurality of count values associated with the entropy-decoded partial data, respectively; and each count value indicates a distance between a boundary storage position of an associated entropy-decoded partial data and a boundary storage position of an adjacent entropy-decoded partial data.

7. The hybrid video decoding apparatus of claim 1, wherein the position information comprises a plurality of physical addresses of the storage device that are associated with the entropy-decoded partial data, respectively.

8. The hybrid video decoding apparatus of claim 1, wherein the picture is partitioned into a plurality of tiles; and the position information associated with the entropy-decoded partial data in the storage device is arranged in the storage device by a tile column order.

9. The hybrid video decoding apparatus of claim 1, wherein the picture is partitioned into a plurality of tiles; and the position information associated with the entropy-decoded partial data in the storage device is arranged in the storage device by a specific order, where the entropy-decoded data are decoded in the specific order if the picture is not partitioned into the tiles.

10. The hybrid video decoding apparatus of claim 1, wherein the picture is partitioned into a plurality of tiles; and the position information associated with the entropy-decoded partial data in the storage device is arranged in the storage device by a decoding order of the entropy-decoded partial data.

11. A hybrid video decoding method comprising:
performing hardware entropy decoding to generate an entropy decoding result of a picture;
allocating a plurality of storage areas in a storage device to buffer a plurality of entropy-decoded partial data, respectively, wherein the entropy-decoded partial data are derived from the entropy decoding result of the picture, and are associated with a plurality of portions of the picture, respectively; and
storing position information into the storage device, wherein the position information is indicative of storage positions of the entropy-decoded partial data in the storage device.

12. The hybrid video decoding method of claim 11, further comprising:
executing a decoding program, by a multi-core processor system, to perform software decoding upon the entropy-decoded partial data in a parallel processing fashion;
wherein one core of the multi-core processor system accesses one of the storage areas to retrieve one entropy-decoded partial data and decodes said one entropy-decoded partial data.

13. The hybrid video decoding method of claim 11, wherein each of the storage areas allocated in the storage device has a predetermined size.

14. The hybrid video decoding method of claim 11, wherein each of the storage areas allocated in the storage device has a variable size that is adaptively set according to a data length of an entropy-decoded partial data stored into the storage area.

15. The hybrid video decoding method of claim 11, wherein the position information comprises a plurality of count values associated with the entropy-decoded partial data stored in a buffer allocated in the storage device, respectively; the storage areas are included in the buffer; and each count value indicates a distance between a boundary storage position of an associated entropy-decoded partial data and a start position of the buffer in the storage device.

16. The hybrid video decoding method of claim 11, wherein the position information comprises a plurality of count values associated with the entropy-decoded partial data, respectively; and each count value indicates a distance between a boundary storage position of an associated entropy-decoded partial data and a boundary storage position of an adjacent entropy-decoded partial data.

17. The hybrid video decoding method of claim 11, wherein the position information comprises a plurality of physical addresses of the storage device that are associated with the entropy-decoded partial data, respectively.

18. The hybrid video decoding method of claim 11, wherein the picture is partitioned into a plurality of tiles; and the position information associated with the entropy-decoded partial data in the storage device is arranged in the storage device by a tile column order.

19. The hybrid video decoding method of claim 11, wherein the picture is partitioned into a plurality of tiles; and the position information associated with the entropy-decoded partial data in the storage device is arranged in the storage device by a specific order, where the entropy-decoded data are decoded in the specific order if the picture is not partitioned into the tiles.

20. The hybrid video decoding method of claim 11, wherein the picture is partitioned into a plurality of tiles; and the position information associated with the entropy-decoded partial data in the storage device is arranged in the storage device by a decoding order of the entropy-decoded partial data.

21. A hybrid video decoding apparatus comprising:
a hardware entropy decoder, arranged to perform hardware entropy decoding to generate an entropy decoding result of a picture; and
a multi-core processor system, arranged to execute a decoding program to perform software decoding upon a plurality of entropy-decoded partial data in a parallel processing fashion, wherein the entropy-decoded partial data are derived from the entropy decoding result of the picture, and are associated with a plurality of portions of the picture, respectively.

22. A hybrid video decoding method comprising:
performing hardware entropy decoding to generate an entropy decoding result of a picture; and
executing a decoding program, by a multi-core processor system, to perform software decoding upon a plurality of entropy-decoded partial data in a parallel processing fashion, wherein the entropy-decoded partial data are derived from the entropy decoding result of the picture, and are associated with a plurality of portions of the picture, respectively.
